(19) United States
(12) Patent Application Publication
(10) Pub. No.: US 2026/0296709 A1
(43) Pub. Date: Oct. 1, 2026

(54) LABELING CONVEYOR SYSTEMS AND METHODS OF LABELING

(71) Applicant: Laitram, L.L.C., Harahan, LA (US)

(72) Inventors: Mark Costanzo, New Orleans, LA (US); Christopher J. Gatz, Noblesville, IN (US); David Herbert Myers, Harahan, LA (US); Eric M. Pressler, Ellicott City, MD (US); Bryant G. Ragan, Metairie, LA (US); Matthew L. Fourney, Laurel, MD (US)

(21) Appl. No.: 19/479,955

(22) PCT Filed: Apr. 23, 2024
(86) PCT No.: PCT/US2024/025843

§ 371 Date: Oct. 29, 2025

Related U.S. Application Data
(60) Provisional application No. 63/466,521, filed on May 15, 2023.

(51) Int. Cl. B65C 1/04; B65C 9/02; B65C 9/40

(52) U.S. Cl. CPC B65C 1/045; B65C 9/02; B65C 9/40; B65C 2009/401

(57) ABSTRACT

A labeling conveyor system and a method for labeling parcels for high throughput. A diverting conveyor selectively directs parcels to separate label applicators depending on a predetermined parcel characteristic, such as height. Parcel sensors determine the characteristic of each parcel.

### BACKGROUND

The invention relates generally to power-driven conveyors and, more particularly, to conveyor systems and methods for applying labels to parcels conveyed past label applicators.

The trend toward online shopping is fueling the growth of the logistics industry. Accurate and rapid delivery of orders requires efficient material handling in warehouses, distribution centers, and last-mile delivery centers. In some material handling systems, labels are applied to a continuous stream of parcels being conveyed to a team of shipping clerks that sort the parcels according to the information on the labels. Because parcels have different heights, including small heights, the label applicator is positioned above the conveyor and applies the labels to the tops of parcels. But to accommodate parcels of different heights, the label applicator has to move vertically to position itself close enough to each parcel to properly apply its label and then, if necessary, to move upward to avoid collisions with a taller next parcel. The time required for the vertical motion necessary to label parcels of different heights effectively is a major bottleneck limiting the system's throughput.

### SUMMARY

A conveyor system embodying features of the invention comprises a diverting conveyor, a parcel sensor, an actuator, and first and second label applicators. The diverting conveyor extends in width from a first side to a second side and includes a conveyor belt advancing upstream to downstream in a conveying direction. The diverting conveyor has diverting elements engaged with parcels. The parcel sensor identifies a characteristic of each parcel. The actuator engages the diverting elements to selectively direct each of the parcels to a first lateral position or a different second lateral position across the width of the conveyor belt depending on the identified characteristic of the parcel. The first label applicator is located along the diverting conveyor to apply labels to parcels at the first lateral position, and the second label applicator is located along the diverting conveyor to apply labels to parcels at the second lateral position.

Another version of a conveyor system for labeling parcels comprises an alignment conveyor aligning parcels along a first side of the alignment conveyor and a diverting conveyor extending in width from a first side to a second side. The diverting conveyor includes a conveyor belt advancing upstream to downstream in a conveying direction. The conveyor belt includes freely rotatable parcel-supporting belt rollers rotatable on axes parallel to the conveying direction. The diverting conveyor receives the aligned parcels from the alignment conveyor along the first side of the diverting conveyor. A first label applicator located along the diverting conveyor applies labels to parcels conveyed along the first side of the diverting conveyor. A second label applicator located along the diverting conveyor applies labels to parcels conveyed along the second side of the diverting conveyor. A plow elevated above the diverting conveyor along the first side across a gap has a gap height that allows parcels having a height less than the gap height to pass through to the first label applicator and blocks parcels having a height greater than the gap height. The plow has an oblique upstream face that diverts blocked parcels atop the belt rollers toward the second side of the diverting conveyor to be labeled by the second label applicator.

Another version of a conveyor system comprises a diverting conveyor extending in width from a first side to a second side and a parcel-height sensor measuring the height of each parcel. The diverting conveyor includes a conveyor belt advancing upstream to downstream in a conveying direction and having parcel-supporting belt rollers rotatable on axes parallel to the conveying direction. An actuator having angularly adjustable actuation rollers contacting the belt rollers selectively changes the direction of rotation of the belt rollers toward the first side or the second side to selectively direct each of the parcels to a first lateral position or a different second lateral position across the width of the conveyor belt depending on the height of each parcel. A first label applicator is located along the diverting conveyor to apply labels to parcels below a predetermined height at the first lateral position. A second label applicator is located along the diverting conveyor to apply labels to parcels above the predetermined height at the second lateral position.

A method for labeling a variety of parcel types comprises: (a) determining the height of each parcel in a stream of parcels; (b) comparing the height of each parcel to a predetermined height; (c) conveying each parcel whose height is less than the predetermined height to a first label applicator that applies a label to the top of the parcel from above; and (d) conveying each parcel whose height exceeds the predetermined height to a second label applicator that applies a label to a side of the parcel.

### BRIEF DESCRIPTION OF THE DRAWINGS

FIG. 1 is a top plan schematic of one version of a labeling conveyor system embodying features of the invention.

FIG. 2 is an isometric view of another version of a labeling conveyor system embodying features of the invention.

FIG. 3 is an enlarged isometric view of the transfer portion of the labeling conveyor system of FIG. 2.

FIG. 4 is an isometric view of label applicators in the labeling conveyor system of FIG. 2.

FIG. 5 is a front elevation view of the labeling conveyor system of FIG. 2.

FIG. 6 is an isometric view of another version of a labeling conveyor system embodying features of the invention.

FIG. 7 is a top plan view of the labeling conveyor system of FIG. 6.

FIG. 8 is an enlarged view partly cut away of the diverting conveyor in the labeling conveyor system of FIG. 6.

FIG. 9 is a top plan view of a portion of another version of a diverting conveyor in a labeling conveyor system with part of the conveyor belt cut away to show a centering actuator.

FIG. 10 is an isometric view of a labeling conveyor system as in FIG. 6 with reject chutes.

FIG. 11 is a top plan view of the labeling conveyor system of FIG. 10.

FIG. 12 is an isometric view of a slat-type labeling conveyor system embodying features of the invention.

FIG. 13 is an isometric view of a slat in the slat-type labeling conveyor system of FIG. 12.

FIG. 14 is an isometric view of a portion of an actuator system for the slat-type labeling conveyor system of FIG. 12.

FIG. 15 is an isometric view of a cross-belt labeling conveyor system embodying features of the invention.

FIG. 16 is an isometric view of a cross-belt carriage of the cross-belt labeling conveyor system of FIG. 15.

FIG. 17 is an isometric view of a cross-belt labeling conveyor system as in FIG. 15 with multiple label applicators at each side of the conveyor.

### DETAILED DESCRIPTION

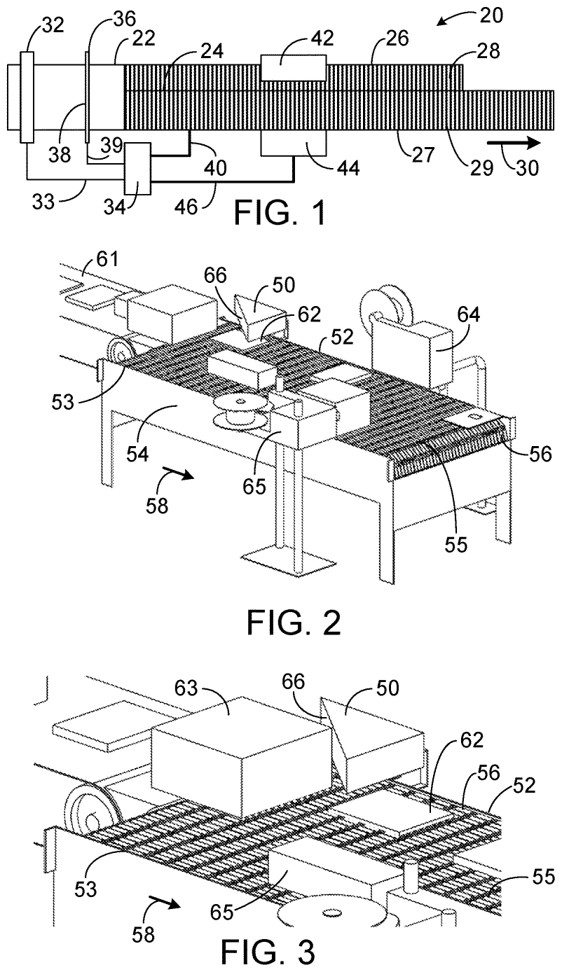

One version of a labeling conveyor system is shown in FIG. 1. The system 20 comprises an infeed conveyor 22 feeding parcels onto a diverting conveyor 24 that extends in width from a first side 26 to a second side 27. The diverting conveyor 24 shown comprises two side-by-side conveyor belts 28, 29 of different widths and lengths. But both belts 28, 29 could be of the same length or width. Or the diverting conveyor 24 could be realized with a single conveyor belt extending in width from the first side 26 to the second side 27. Both the infeed conveyor 22 and the diverting conveyor 24 convey parcels upstream to downstream in a conveying direction 30.

The term “parcel” is used throughout the description and claims as a generic term encompassing packages, cartons, boxes, polybags, flats, envelopes, and any container that is to be handled.

A parcel scanner 32, such as a camera or a code reader, scans parcels as they are conveyed past on the infeed conveyor 22. The scanned information is sent via a data line 33 to a controller 34 to identify each parcel. A parcel-height sensor 36 measures the heights of parcels as they pass a measurement position 38 on the infeed conveyor 22. The height measurements are sent via a data line 39 to the controller 34.

The controller 34, which may be a single programmable processor or a network of two or more processors, executes program steps in an associated program memory to identify each parcel, record each parcel's height, and compare the height of each parcel to a predetermined height. If a parcel's height is less than the predetermined height, the controller 34 sends signals to actuators in the diverting conveyor 24 over control lines 40 to direct the parcel to a first lateral position to receive a label from a first label applicator 42. If, on the other hand, a parcel's height exceeds the predetermined height, the controller 34 sends signals via the control lines 40 to the actuators to direct the parcel to a second lateral position to receive a label from a second label applicator 44. With knowledge of the speeds of the conveyors 22, 24 from shaft encoders, for example, the lateral positions of the parcels as they're fed onto the diverting conveyor, and their identities, the controller 34 accurately tracks the parcels and controls their trajectories on the diverting conveyor.

In this example, the first label applicator 42, which is at the first side 26 of the diverting conveyor 24, is positioned above the conveyor to apply labels to the tops of short parcels as they pass. The second label applicator 44, which is at the second side 27 of the diverting conveyor 24, applies labels to the outermost sides of tall parcels. But, like the first label applicator 42, the second label applicator 44 could be positioned above the diverting conveyor 24 to apply labels to the tops of the taller parcels. And although the two label applicators 42, 44 are shown at the first and second sides 26, 27 of the diverting conveyor 24, the first or second lateral labeling positions could be located nearer the center of the diverting conveyor as long as the label applicator is a top labeler. The diverting conveyor could even have a third parcel-height range and direct parcels in that range to a third lateral labeling position and on to a third label applicator. After the labels are applied to the short parcels by the first label applicator 42, the first conveyor belt 28 diverts the parcels to the second conveyor belt 29 for downstream handling. The controller 34 assigns labels to the parcels and signals the label applicators over label control lines 46 to apply the assigned labels as the parcels pass. The controller 34 also controls downstream actuators that direct the short parcels onto the second conveyor belt 29 after labels are applied.

Although the controller 34 is shown in this example as receiving information from both the parcel scanner 32 and the parcel-height sensor 36, the scanner could be used without the height sensor if a parcel characteristic other than height is used to segregate the parcels for labeling. For example, the scanner 32 could be used to measure parcel size, parcel length, or parcel type, such as corrugated box or polybag, and the parcel assigned to a label applicator by the controller 34 based on that characteristic. Or the controller 34 could merely count the number of parcels indicated by the scanner 32 in sequential order as they pass the parcel sensor on the infeed conveyor 22 and direct every odd-numbered parcel to the first label applicator 42 and every even-numbered parcel to the second label applicator 44. Thus, either the parcel scanner 32 or the parcel-height sensor 36, alone or together, can serve as a parcel sensor sending parcel sensor signals identifying a characteristic of each parcel to the controller.

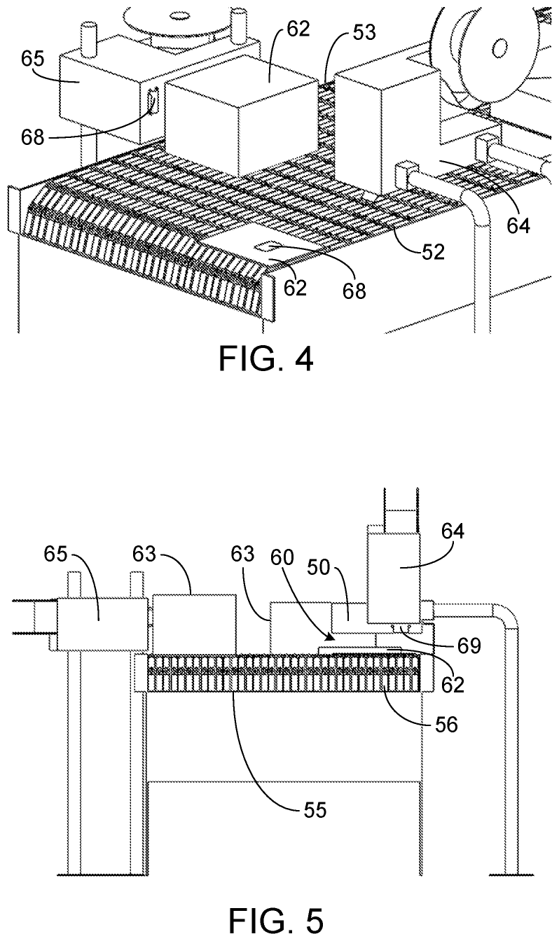

The labeling conveyor system of FIGS. 2-5 segregates parcels by height without using a parcel-height sensor. Instead, a plow 50 is positioned along a first side 52 of a diverting conveyor 54, which includes a conveyor belt 55 having parcel-supporting rollers 56 that rotate freely on axes of rotation that extend parallel to a conveying direction 58. The plow 50 is spaced above the tops of the belt rollers 56 by a gap 60. An infeed alignment conveyor 61 aligns the stream of parcels so that they collide with the plow or pass under it. The height of the gap 60 allows short parcels 62 to pass under the plow 50. After passing through the gap 60, the short parcels 62 are labeled by a first label applicator 64. The applicator 64 applies labels to the tops of the short parcels at a first lateral position across the width of the diverting conveyor 54. The plow 50 blocks tall parcels 63 that don't fit in the gap 60. A front face 66 on the plow 50, oblique to the conveying direction 58, guides the intercepted tall parcels 63 across the freely rotatable belt rollers 56 in the conveyor belt 55 toward a second side 53 of the diverting conveyor 54. The belt rollers 56 are not rotated by an actuator. As the conveyor belt 55 advances in the conveying direction 58, the blocking oblique front face 66 of the plow 50 causes the belt rollers 56 in contact with the bottoms of the tall parcels 63 to rotate toward the second side 53 and translate the parcels toward the second side. After the tall parcels 63 progress past the plow's oblique face 66, their momentum carries them atop the belt rollers 56 farther across the conveyor belt 55 to the second lateral position to be labeled by a second label applicator 65. Actuation zones, as described subsequently in more detail, could alternatively be positioned along the second side to actuate the belt rollers 56 to translate the tall parcels against a sidewall at the second side 53.

The first label applicator 64 affixes labels 68 to the tops of the short parcels. The second label applicator 65 affixes labels 68 to the outermost sides of the tall parcels 63. The label applicators 64, 65 don't have to contact the parcels 62, 63. Rather they use pneumatic pressure in the form of an air jet to blow the labels 68 onto the parcels 62, 63 over a short distance. Because the tall parcels 63 are conveyed along the second side 53 of the conveyor 54, the side-applying second label applicator 65 does not have to retract to avoid collisions with the tallest parcels or to change its position to apply top labels at different heights. The outermost sides of the tall parcels 63 are all close enough to the second label applicator 65 that it can remain stationary. If the height of the plow's gap 60 is small, the distance from the top of the belt rollers 56 to the first label applicator's label mouth 69 is just as small, and the first label applicator 64 can be stationary too. If the gap height is not so small, the first label applicator 64 may be made movable. But the range of movement can be small. By minimizing or totally eliminating the range of movement of the two label applicators 64, 65, parcel throughput is increased significantly.

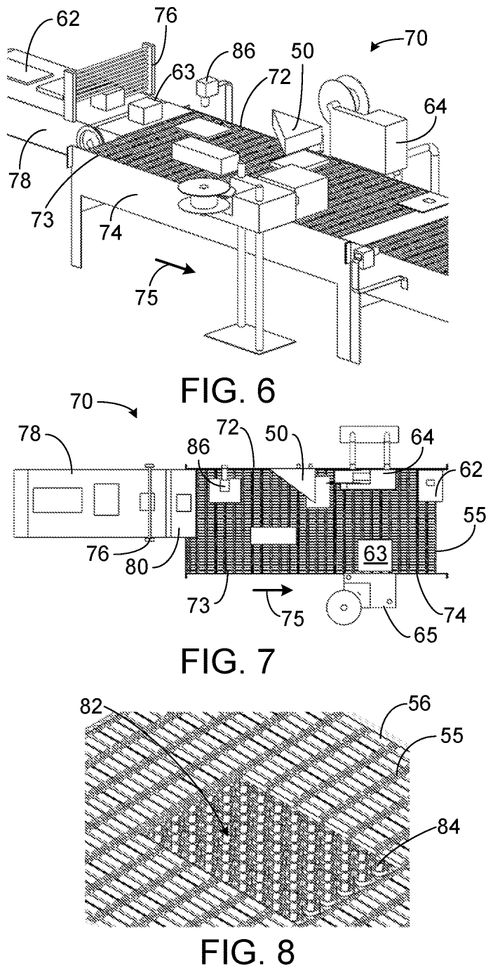

Unlike the belt rollers 56 in the passive diverting conveyor 54 of FIGS. 2-5, the belt rollers 56 in the labeling conveyor 70 in FIGS. 6-8 are engaged by an actuation system that selectively engages and actuates the belt rollers in multiple actuation zones along the length and across the width of the conveyor to rotate toward either a first side 72 or a second side 73 of a diverting conveyor 74. In that way, parcels can be directed across the width of the conveyor 74 as they advance in a converging direction 75. Thus, the belt rollers 56 serve as diverting elements engaged by the actuation system.

The parcels pass through a parcel sensor 76 on an infeed conveyor 78. The parcel sensor 76 illustrated in FIG. 6 is a light curtain that is used by the controller to determine the heights of the parcels 62, 63. The lengths of the parcels in the conveying direction can also be determined by the controller from the light-curtain signal if the parcels are singulated. Other parcel-height sensors, such as rangefinders and cameras above the infeed conveyor 78 or side-positioned cameras or photo eyes, could alternatively be used to measure parcel height. Parcel length could be measured by cameras or photo eyes. Once a parcel 62, 63 is transferred from the infeed conveyor 78 to the diverting conveyor 74 over a transfer surface 80, which could be a plate, roller, or narrow belt roller, the controller sends control signals to actuators 82 in each carryway actuator zone under an identified parcel to selectively engage the belt rollers 56. The engagement causes the belt rollers 56 to rotate either toward the first side 72 or toward the second side 73 of the conveyor depending on the height of the parcel. Short parcels 62 are directed toward the first side 72 to be labeled by the first label applicator 64, which applies labels to the parcel tops. Tall parcels 63 are directed toward the second side 73 to be labeled by the second label applicator 65, which applies labels to outermost sides of the parcels as they pass.

A suitable actuator 82 for the roller belt 55 is shown in FIG. 8. The actuator 82 comprises arrays of angularly adjustable caster rollers 84. Each array defines an actuator zone. All the caster rollers 84 in each zone are adjusted together to a first angle in which the axes of rotation of the caster rollers and of the belt rollers 56 are clockwise oblique to each other to cause the belt rollers to rotate toward one side of the diverting conveyor 74 as the belt 55 advances. When the controller commands an actuator 82 to adjust its caster rollers 84 to a second angle in which the axes of rotation of the caster rollers and of the belt rollers 56 are counterclockwise oblique to each other, the belt rollers rotate toward the opposite side.

A plow 50 is positioned above the belt rollers 56 slightly upstream of the first label applicator 64 to protect the applicator from collisions with tall parcels 63 that could mistakenly be directed to the first lateral position at the conveyor belt 55 in line with the label applicator. Like the plow in the system of FIG. 2, the protective plow 50 is elevated above the belt rollers 56 across a gap that allows short parcels 62 to pass through to the first label applicator 64.

An optional camera 86 serving as a lateral position sensor senses the lateral positions of the short parcels 62. The controller receives a lateral-position signal from the sensor 86 and commands the actuators 82 as required to align the short parcels 62 relative to the lateral position of the first label applicator 64 as necessary to ensure that the labels are applied in a convenient place on the tops of the parcels.

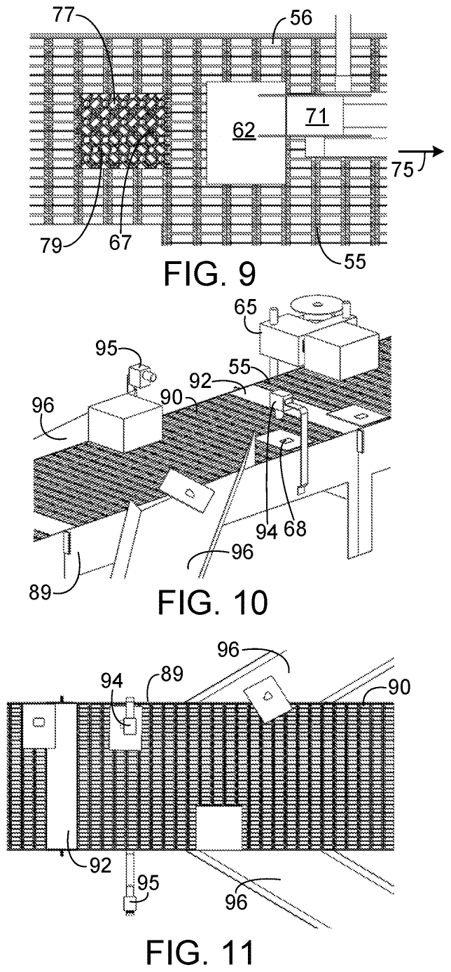

An alternative version of a diverting conveyor is shown in FIG. 9. A centering actuator 67 is positioned below the conveyor belt 55 upstream of a label applicator 71 in a centering zone of the diverting conveyor. The centering actuator 67 and the applicator 71 may be positioned at or spaced apart from the sides of the diverting conveyor. The centering actuator 67 differs from the angularly adjustable roller actuators (82, FIG. 7) positioned elsewhere under the conveyor belt 55 in that the actuating caster rollers 77, 79 in the array rotate on non-adjustable fixed axes angled oblique to the conveying direction 75. The actuating rollers 77 in a first side of the centering array are angled in a first direction to cause the belt rollers 56 they engage to rotate toward an opposite second side of the array. And the actuating rollers 79 in the second side of the array are angled in a second direction to cause the belt rollers 56 they engage to rotate toward the first side. The effect is that parcels laterally positioned on the conveyor belt 55 to enter the centering zone are centered with respect to the actuator 67. And the centering zone is properly laterally aligned with the label applicator 71 so that small parcels 62 directed to the centering zone are delivered to the label applicator 71 in a position to receive labels in a convenient location on the parcel tops. The centering zone makes the optional position-sensing camera 86 of FIG. 7 unnecessary.

An extension 89 of the diverting conveyor 54 is shown in FIGS. 10 and 11. As shown, the extension includes another roller conveyor belt 90 with caster-roller actuation zones. The roller conveyor belt 90 receives parcels 62, 63 from the upstream conveyor belt 55 across a transfer plate 92 or a transfer roller or transfer rollers. But the extension could be realized as an extended length of the conveyor belt 55 instead of as a separate belt 90. Optional quality-control cameras 94, 95 are positioned along the diverting conveyor 89 downstream of the first and second label applicators 64, 65 to produce digital images of the labels 68 on the parcels along the first and second lateral positions. The digital images are sent to the controller. If the controller is unable to decipher a label or a label is missing, the controller commands the actuators in zones under the diverting conveyor to direct the parcels with missing, illegible, or otherwise defective labels off one or both sides of the diverting conveyor extension 89 and onto reject conveyors 96. If enough parcels are missing labels, the controller can set an alarm or otherwise alert operators that there could be a problem with a label applicator 64, 65 or with the labels' adhesive. (Labels that land on the conveyor belts 55, 90 can jam the belt rollers.) Rejected parcels can then be manually returned to the infeed conveyor or recirculated to the infeed conveyor by a recirculation conveyor (not shown). The reject conveyors 96 are shown as chutes in FIGS. 10 and 11 but could be realized as conveyor belts, powered conveyors, or gravity rollers, for example. Alternatively, rejected parcels could be conveyed off the downstream end of the conveyor system to a reject conveyor or reject-collection receptacle.

FIG. 12 shows a labeling conveyor system that differs from the system of FIG. 6 in that the diverting elements in a diverting conveyor 100 are parcel-supporting slats 102. The slats 102 are supported on rails 104 whose ends are attached to chains 106 motor-driven by sprockets (not shown). The slats 102 are selectively driven laterally across the width of the diverting conveyor 100 depending on whether a parcel is assigned to the first label applicator 64 or the second label applicator 65.

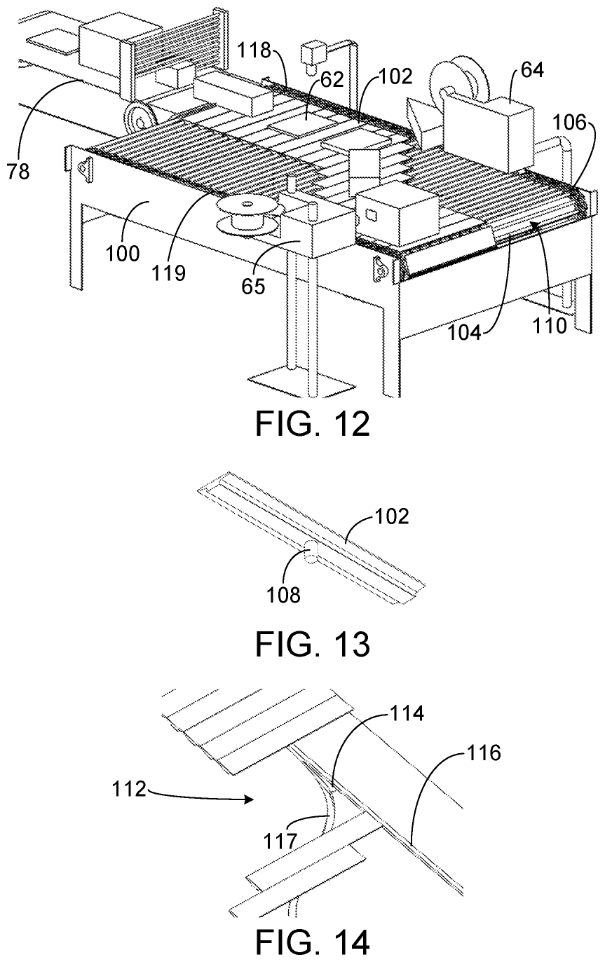

As shown in FIG. 13, each slat 102 has a pin 108 protruding from its bottom. The pin 108 extends through a laterally elongated space 110 between consecutive rails 104 supporting the slat 102. The pin 108 is selectively engaged and guided by an actuator guide network 112 in the carryway as shown in FIG. 14. An actuating diverter 114 controlled by the controller pivots counterclockwise to guide the pins 108 of the slats 102 bearing short parcels 62 without diversion into a first guide track 116 along a first side 118 of the diverting conveyor 100 to the first label applicator 64. The controller pivots the diverter 114 clockwise to guide the pins 108 of the slats 102 bearing tall parcels 63 into a second guide track 117 that guides the slats toward a second side 119 of the diverting conveyor 100 to the second label applicator 65. A conventional guide network in the slat belt's returnway returns the slats 102 to the first side 118 in position to receive parcels aligned at the first side by the infeed conveyor 78.

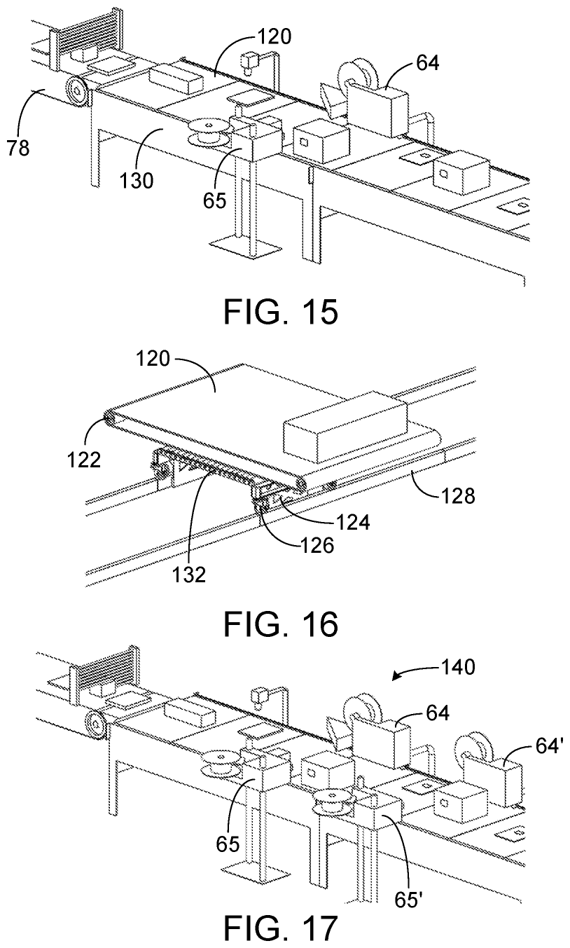

Another alternative diverting conveyor is shown in FIGS. 15 and 16, in which the parcel-supporting diverting elements are cross belts 120. Each cross belt 120 is trained and tensioned around rollers 122 supported on a carriage 124. An optional bed of small idle rollers 132 supports the cross belt 120 in its return in low-friction rolling contact. The carriage has wheels 126 that ride on rails 128. The carriages 124 are linked end to end to form a continuous chain. One of the rollers 122 is powered by a motor (not shown) in the carriage. The tensioned engagement of the rollers 122 with the cross belt 120 drives the cross belt laterally across the width of the diverting conveyor 130. In that way, the motor and the powered roller 122 serve as actuators driving the cross belt selectively in either direction. The motor in each carriage 124 is powered through one or both of the electrically conductive metal rails 128 and metal wheels 126, inductively, or by a battery (not shown) mounted in the carriage. Control signals from the controller are sent wirelessly to the motors or ohmically through the rails 128 and wheels 126 to direct the cross belt 120 to deliver a parcel to its assigned first or second label applicator 64, 65. The infeed conveyor 78 does not have to align parcels for delivery to the cross-belt diverting conveyor 130. Instead of a motor-driven cross belt, a cross belt having a pin depending downward from the cross belt in its lower return could be actuated by a guide network as for the slat-type conveyor.

The labeling conveyor system 140 shown in FIG. 17 further increases throughput with additional label applicators 64′, 65′ supplementing the upstream applicators 64, 65. In this case, the controller commands each label applicator to apply a label to every other parcel that passes by. If more than two label applicators are used on each side, the controller commands the label applicators to apply labels in a round-robin fashion. In that way, each parcel is labeled only once. Although multiple label applicators are shown with the cross-belt diverting conveyor, they could be used with any of the diverting conveyors described.

The quality-control cameras and the reject conveyors shown in FIGS. 10 and 11 can be used with any of the labeling conveyor systems described in detail and in others. The lateral position sensor 86 shown in FIGS. 6 and 7 can be used with the cross-belt diverting conveyor 130 of FIG. 15. And the protective plow 50 described in connection with the diverting conveyor 74 of FIG. 6 can be used in the slat-type and cross-belt labeling systems.

What is claimed is:

1. A conveyor system comprising:
a diverting conveyor extending in width from a first side to a second side and including a conveyor belt advancing upstream to downstream in a conveying direction and having diverting elements engaged with parcels;
a parcel sensor identifying a characteristic of each parcel;
an actuator engaging the diverting elements to selectively direct each of the parcels to a first lateral position or a different second lateral position across the width of the conveyor belt depending on the identified characteristic of the parcel;
a first label applicator located along the diverting conveyor to apply labels to parcels at the first lateral position;
a second label applicator located along the diverting conveyor to apply labels to parcels at the second lateral position.

2 The conveyor system as claimed in claim 1 wherein the parcel sensor senses the height of each parcel as the identified characteristic.

3. The conveyor system as claimed in claim 2 wherein the parcel sensor is a light curtain, photo eye, camera, or rangefinder.

4. The conveyor system as claimed in claim 1 wherein the parcel sensor senses the shape of each parcel or the type of each parcel as the identified characteristic.

5. The conveyor system as claimed in claim 1 wherein the identified characteristic is the sequential order of the parcels.

6. The conveyor system as claimed in claim 1 wherein the diverting elements are parcel-supporting belt rollers rotatable on axes parallel to the conveying direction and wherein the actuator includes angularly adjustable actuation rollers contacting the belt rollers to selectively change the direction of rotation of the belt rollers toward the first side or the second side of the diverting conveyor.

7. The conveyor system as claimed in claim 1 wherein the diverting elements are parcel-supporting slats and wherein the actuator selectively guides the slats across the width of the diverting conveyor to translate parcels.

8. The conveyor system as claimed in claim 1 wherein the diverting elements are parcel-supporting cross belts that translate parcels across the width of the diverting conveyor and wherein the actuator selectively advances the cross belts across the width of the diverting conveyor to translate parcels.

9. The conveyor system as claimed in claim 1 wherein the first lateral position is along the first side of the diverting conveyor and the second lateral position is along the second side of the diverting conveyor.

10. The conveyor system as claimed in claim 1 comprising at least two first label applicators spaced apart in the conveying direction at the first lateral position and at least two second label applicators spaced apart in the conveying direction at the second lateral position, wherein the at least two first label applicators apply labels to the parcels at the first lateral position in round-robin fashion and the at least two second label applicators apply labels to the parcels at the second lateral position in round-robin fashion to increase throughput.

11. The conveyor system as claimed in claim 1 wherein the first label applicator applies labels to the tops of parcels and the second label applicator applies labels to the sides of parcels.

12. The conveyor system as claimed in claim 11 wherein the second label applicator is at the second side of the diverting conveyor and the first label applicator is between the first and second sides of the diverting conveyor.

13. The conveyor system as claimed in claim 11 wherein the actuator engages the diverting elements to direct parcels having a height less than a predetermined height to the first position to be labeled by the first label applicator and to direct parcels having a height greater than the predetermined height to the second position to be labeled by the second label applicator.

14. The conveyor system as claimed in claim 11 comprising a lateral-position sensor sensing the lateral position of the parcels, wherein the actuator engages the diverting elements to align the parcels to be labeled by the first label applicator with the first label applicator so that the labels are applied at convenient positions on tops of the parcels.

15. The conveyor system as claimed in claim 11 comprising a centering zone of the diverting conveyor laterally positioned between the first and second sides of the diverting conveyor and wherein the first label applicator is located at a lateral position between the first and second sides of the diverting conveyor, wherein parcels to be labeled by the first label applicator are directed through the centering zone to be delivered to the first label applicator so the labels are applied at convenient positions on tops of the parcels.

16. The conveyor system as claimed in claim 1 comprising a plow at the first lateral position upstream of the first label applicator and spaced above the diverting conveyor across a gap whose height is less than a predetermined height to block parcels whose heights are greater than the predetermined height from colliding with the first label applicator, wherein the plow has an oblique face arranged to divert blocked parcels toward the second side of the diverting conveyor.

17. The conveyor system as claimed in claim 1 comprising:
first and second quality-control cameras positioned along the diverting conveyor at the first and second lateral positions downstream of the first and second label applicators to produce images of the labels on the parcels;
wherein the actuator engaging the diverting elements selectively directs parcels with defective or missing labels off the first side of the diverting conveyor;
a reject conveyor positioned along the first side or the second side to receive the parcels whose labels are defective from the diverting conveyor.

18. The conveyor system as claimed in claim 17 wherein reject conveyors are positioned at both the first and second sides and wherein the actuator selectively directs parcels with defective labels to the reject conveyors at first side and the second sides.

19. The conveyor system as claimed in claim 1 comprising an infeed conveyor feeding parcels to the diverting conveyor, wherein the parcel sensor identifies the characteristic of each parcel as it passes a sensing position on the infeed conveyor.

20. The conveyor system as claimed in claim 1 comprising a controller receiving a parcel sensor signal from the parcel sensor indicating the characteristic of each parcel and selectively controlling the actuator to direct each of the parcels to the first lateral position or the second lateral position depending on the identified characteristic of the parcel.

21. The conveyor system as claimed in claim 1 wherein the diverting conveyor includes two conveyor belts side by side.

22. A conveyor system comprising:
an alignment conveyor aligning parcels along a first side of the alignment conveyor;
a diverting conveyor extending in width from a first side to a second side and including a conveyor belt advancing upstream to downstream in a conveying direction and including freely rotatable parcel-supporting belt rollers rotatable on axes parallel to the conveying direction, wherein the diverting conveyor receives the aligned parcels from the alignment conveyor along the first side of the diverting conveyor;
a first label applicator located along the diverting conveyor to apply labels to parcels conveyed along the first side of the diverting conveyor;
a second label applicator located along the diverting conveyor to apply labels to parcels conveyed along the second side of the diverting conveyor;
a plow elevated above the diverting conveyor along the first side across a gap having a gap height that allows parcels having a height less than the gap height to pass through to the first label applicator and blocks parcels having a height greater than the gap height;
wherein the plow has an oblique upstream face that diverts blocked parcels atop the belt rollers toward the second side of the diverting conveyor to be labeled by the second label applicator.

23. The conveyor system as claimed in claim 22 wherein the first label applicator applies labels to the tops of the parcels and the second label applicator applies labels to the sides of the parcels.

24. A conveyor system comprising:
a diverting conveyor extending in width from a first side to a second side and including a conveyor belt advancing upstream to downstream in a conveying direction and having parcel-supporting belt rollers rotatable on axes parallel to the conveying direction;
a parcel-height sensor measuring the height of each parcel;
an actuator having angularly adjustable actuation rollers contacting the belt rollers to selectively change the direction of rotation of the belt rollers toward the first side or the second side to selectively direct each of the parcels to a first lateral position or a different second lateral position across the width of the conveyor belt depending on the height of each parcel;
a first label applicator located along the diverting conveyor to apply labels to parcels below a predetermined height at the first lateral position;
a second label applicator located along the diverting conveyor to apply labels to parcels above the predetermined height at the second lateral position.

25. The conveyor system as claimed in claim 24 comprising an infeed conveyor delivering the parcels to the diverting conveyor and wherein the parcel-height sensor measures the height of each parcel as it passes a measurement position of the infeed conveyor.

26. The conveyor system as claimed in claim 24 wherein the first lateral position is along the first side of the diverting conveyor and the second lateral position is along the second side of the diverting conveyor.

27. The conveyor system as claimed in claim 24 wherein the first label applicator applies labels to the tops of parcels and the second label applicator applies labels to the sides of parcels.

28. The conveyor system as claimed in claim 27 comprising a plow at the first lateral position upstream of the first label applicator and spaced above the diverting conveyor across a gap whose height is less than the predetermined height to block parcels whose heights are greater than the predetermined height from colliding with the first label applicator, wherein the plow has an oblique face arranged to divert blocked parcels toward the second side of the diverting conveyor.

29. The conveyor system as claimed in claim 24 comprising:
first and second quality-control cameras positioned along the diverting conveyor at the first and second lateral positions downstream of the first and second label applicators to produce images of the labels on the parcels;
wherein the actuator adjusts the angle of the angularly adjustable actuation rollers contacting the belt rollers is selectively adjusted to cause the belt rollers to rotate in a direction that directs parcels with defective or missing labels off the first side of the diverting conveyor;
a reject conveyor positioned along at least one of the first and second sides of the diverting conveyor to receive the parcels whose labels are defective from the diverting conveyor.

30. The conveyor system as claimed in claim 24 wherein the diverting conveyor includes two conveyor belts side by side.

31. A method for labeling a variety of parcel types, the method comprising:
determining the height of each parcel in a stream of parcels;
comparing the height of each parcel to a predetermined height;
conveying each parcel whose height is less than the predetermined height to a first label applicator that applies a label to the top of the parcel from above;
conveying each parcel whose height exceeds the predetermined height to a second label applicator that applies a label to a side of the parcel.

32. The method of claim 31 comprising centering each parcel whose height is less than the predetermined height with respect to the first label applicator.

33. The method of claim 31 comprising imaging the labels applied by the first and second applicators to the parcels and removing parcels with illegible labels.

34. The method of claim 31 comprising blocking parcels whose height exceeds the predetermined height from colliding with the first label applicator.
